(19) United States
(12) Patent Application Publication
(10) Pub. No.: US 2009/0254932 A1
(43) Pub. Date: Oct. 8, 2009

(54) INSERTING ADVERTISEMENTS IN A TELEVISION PROGRAM

(75) Inventors: Weiran Wang, Shanghai (CN); Liang Gan, Shanghai (CN); Donghai Yu, Shanghai (CN); Stijn Jans, Hong Kong (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/305,210

(22) PCT Filed: Jun. 22, 2007
(86) PCT No.: PCT/IB07/52417

§ 371 Date: Dec. 17, 2008

(30) Foreign Application Priority Data
Jun. 27, 2006 (CN) 200610100035.8

(51) Int. Cl. H04H 60/32

(52) U.S. Cl. 725/14; 725/34; 725/109

(57) ABSTRACT

The present invention relates to a method and apparatus for broadcasting television programs, in particular to a method and apparatus for inserting an advertisement into a broadcast television program. An object of the invention is to provide a method for inserting an advertisement segment into a television program of an Internet Protocol Television (IPTV) channel, the method comprises the steps of: receiving a request from a user that asks for viewing the television program; monitoring the viewing behavior of the user toward the IPTV channel according to an advertisement policy of the IPTV channel, the advertisement policy comprising providing an advertisement segment based on the user's viewing behavior on the IPTV channel; determining whether the monitored viewing behavior matches the advertisement policy; if the monitored viewing behavior matches the advertisement policy, inserting the advertisement segment into the television program. According to the invention, during the process of viewing a program, a user will have to view a certain amount of advertisements according to a predefined advertisement policy even though the user relocates the television program.

### FIELD OF THE INVENTION

The present invention relates to a method and apparatus for broadcasting a television program, in particular to a method and apparatus for inserting advertisements in a broadcast television program.

### BACKGROUND OF THE INVENTION

A broadcast television system delivers television programs to families across the whole world. A television propagator delivers advertisements and other sales promotion programs in addition to television programs. Advertising agents pay the television propagator in order that advertisements can be propagated to a wide range of television viewers. Therefore, the television propagator hopes the users view these advertisements and other sales promotion programs rather than ignoring them.

With the development of the information processing technology and the content distribution technology, Internet Protocol Television (IPTV) technology has been further developed. IPTV means to provide digital television services in unicast or multicast mode over an IP protocol based network.

In the prior art, South Korea patent application KR15900/2002 (invented by Choi Soo Kyoung, et al, applied by SAMSUNG Electronics Co, Ltd, and filed on Mar. 23, 2002) has disclosed a method and apparatus for transmitting VOD (video on demand) data stream services that provide advertisements according to the user's preference. A VOD server for providing VOD data stream services comprises: a service control unit, for providing the user with the multimedia contents and specific advertisement contents selected by a user; and a data storage unit, for storing multimedia contents, advertisement contents, and user data.

Because of the frequent interact nature of IPTV, a user of IPTV may skip advertisement segments by relocating or fast forwarding during the process of viewing a television program. Therefore, a novel method and apparatus are needed in order that a user will have to view a certain amount of advertisements during the process of viewing the television programs, a suitable tradeoff may be found among the benefit of the advertising agents, the benefit of the television propagator and that of the user.

### OBJECT AND SUMMARY OF THE INVENTION

The invention is an improvement to the technical solution of the prior art. The invention provides a novel method and apparatus, with which a user will, in the process of viewing a television program, have to view a certain amount of advertisement segments in accordance with a predefined advertisement policy even though the user relocates the television program.

An object of the invention is to provide a method for inserting an advertisement segment into a television program of an IPTV channel, the method comprises the steps of: receiving a request from a user that asks for viewing the television program; monitoring the viewing behavior of the user on the IPTV channel according to an advertisement policy of the IPTV channel, the advertisement policy comprising providing an advertisement segment based on the user's viewing behavior on the IPTV channel; determining whether the monitored viewing behavior matches the advertisement policy; if the monitored viewing behavior matches the advertisement policy, inserting the advertisement segment into the television program.

According to an embodiment of the method of the invention, the inserting step comprises inserting the advertisement segment into the television program to generate an integrated stream.

According to an embodiment of the method of the invention, said advertisement policy comprises providing the user with the advertisement segment based on the length of time during which the user has viewed the television program, wherein the monitoring step comprises recording the time for the user to view the television program.

According to another embodiment of the method of the invention, said advertisement policy comprises providing the user with the advertisement segment based on the program location of the television program viewed by the user, wherein the monitoring step comprises tracking the location of a segment of the television program viewed by the user in the television program.

According to yet another embodiment of the invention, said advertisement policy comprises providing the advertisement segment based on the type of the television program the user is viewing, wherein the monitoring step comprises determining the type of the television program being viewed by the user.

According to the invention, a television propagator customizes an advertisement policy for each IPTV channel, the advertisement policy provides advertisement segments based on the user's viewing behavior toward a television program of the IPTV channel. According to the method of the invention, in accordance with the advertisement policy, the viewing behavior of the user toward the television program is monitored, and an advertisement segment is inserted into the television program when it is determined that the viewing behavior matches the viewing behavior defined by the advertisement policy.

Another object of the invention is to provide an apparatus for inserting an advertisement segment into a television program of an IPTV channel, the apparatus comprises: a receiver, for receiving a request from a user that asks for viewing the television program; a monitor, for monitoring the viewing behavior of the user on the IPTV channel according to an advertisement policy of the IPTV channel, the advertisement policy comprising providing an advertisement segment based on the viewing behavior of the user on the IPTV channel; a matcher, for determining whether the monitored viewing behavior matches the advertisement policy; an inserter, for inserting the advertisement segment into the television program if the viewing behavior matches the advertisement policy.

Yet another object of the invention is to provide a computer program product for inserting an advertisement segment into a television program of an IPTV channel, the computer program product comprises: code for receiving a request from a user that asks for viewing the television program; code for monitoring the viewing behavior of the user on the IPTV channel according to an advertisement policy of the IPTV channel, the advertisement policy comprising providing an advertisement segment based on the viewing behavior of the user on the IPTV channel; code for determining whether the monitored viewing behavior matches the advertisement policy; and code for inserting the advertisement segment into the television program if the viewing behavior matches the advertisement policy.

Yet another object of the invention is to provide a storage carrier containing the aforesaid computer program product.

Other objects and achievements of the invention will be apparent, and a full understanding of the invention can be obtained through the following description with reference to the accompanying drawings and claims.

### BRIEF DESCRIPTION OF THE INVENTION

With exemplary embodiments and appended schematic figures, the invention and the related advantages will be further stated, in the drawings:

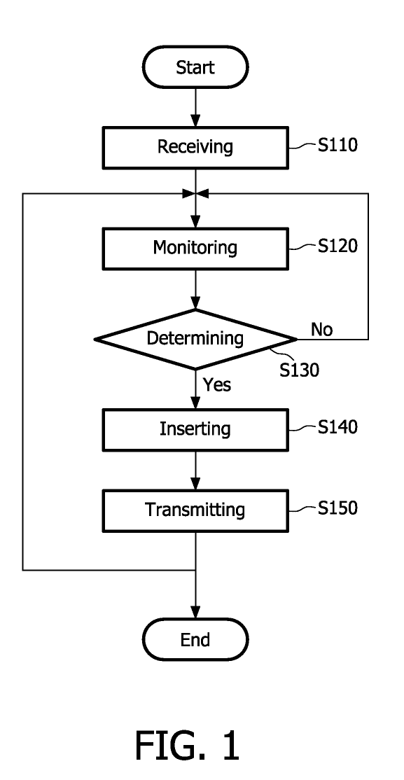

FIG. 1 is the schematic flow chart of a method for inserting an advertisement segment into a television program of an IPTV channel according to an embodiment of the invention;

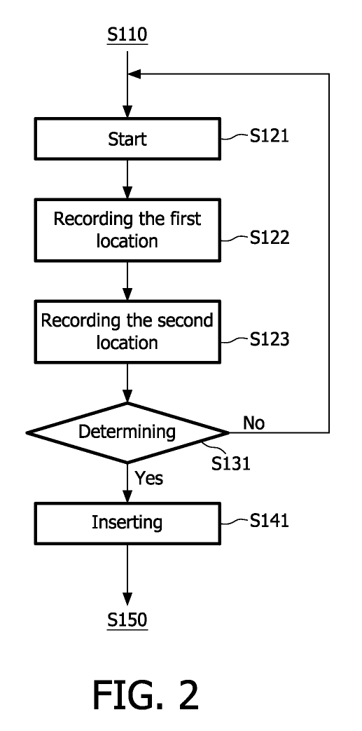

FIG. 2 is the schematic flow chart of a method for inserting an advertisement segment into a television program of an IPTV channel according to another embodiment of the invention;

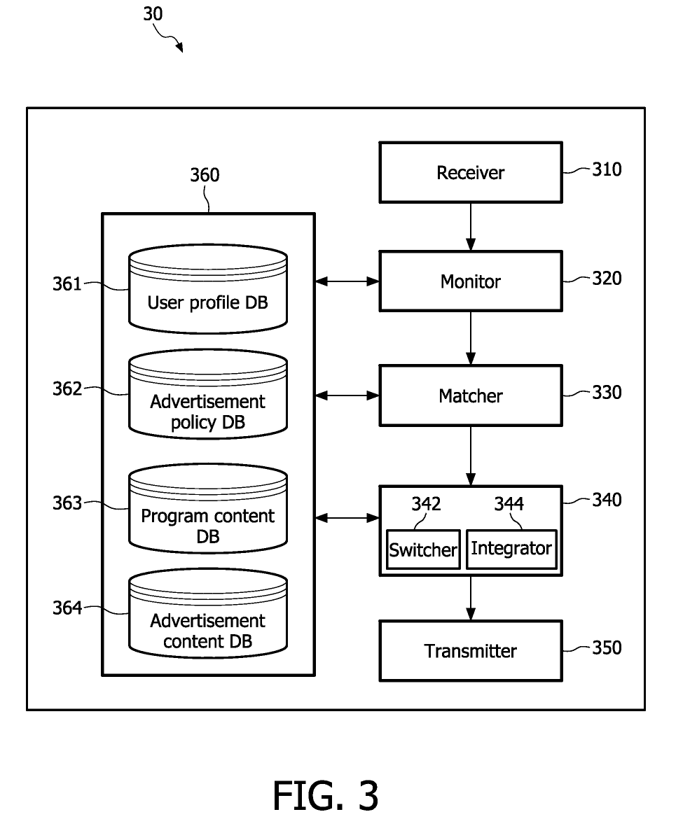

FIG. 3 is the schematic structural diagram of an apparatus for inserting an advertisement segment into a television program of an IPTV channel according to an embodiment of the invention.

The corresponding features are represented by the same signs in the drawings.

### DETAIL DESCRIPTION OF THE INVENTION

FIG. 1 is the schematic flow chart of a method for inserting an advertisement segment into a television program of an IPTV channel according to an embodiment of the invention. The television program is being viewed by a user.

An Internet protocol digital television broadcaster or an Internet protocol digital television operator carries out a predefined advertisement policy for each IPTV channel. The advertisement policy of an IPTV channel may comprise: providing the user with an advertisement segment based on the length of time during which the user has viewed the television program; providing the user with the advertisement segment based on the program location of the television program viewed by the user; providing the user with the advertisement segment based on the type of the television program the user is viewing. Each IPTV channel may perform the same advertisement policy as other IPTV channels, or a different one from the others. The advertisement policy of an IPTV channel may preferably comprise sending to the user the user's favorite advertisements in accordance with the user's preference as much as possible.

The length of time during which a user has viewed the television program may be toward an IPTV channel, a television program, or a plurality of IPTV channels.

Furthermore, the plurality of IPTV channels can perform a common advertisement policy. For example, CCTV-1, CCTV-2, CCTV-3, CCTV-4, CCTV-5 and CCTV-6 perform the following advertisement policy: providing an advertisement segment of three minutes to a user when the viewer has viewed the television programs of the above six IPTV channels over 30 minutes. Another example, providing an advertisement segment of two minutes to a user when the viewer has viewed news programs of these four channels, i.e. CCTV-1, CCTV-2, CCTV-3 and CCTV-4, over 30 minutes.

Furthermore again, the same IPTV channel can establish different advertisement policies for different time periods every day, different viewer groups in one week or one year. An IPTV channel may establish a separate advertisement policy for a television program, i.e., the viewing behavior of a user toward other programs of the IPTV channel does not influence the execution of that advertisement policy.

Anyway, the Internet protocol digital television broadcaster or the Internet protocol digital television operator can flexibly establish the advertisement policies for each of the IPTV channels as needed.

Firstly, a request from a user is received, the request asks for viewing a television program of an IPTV channel (step S110). Upon this request, the television program is delivered to the user in a IPTV propagation mode.

The request may comprise the user's information and the information of television program.

The user's information may contain the registration information, the account information and the history of viewing the television programs of the IPTV, of the user.

The information of the television program may originate from an electronic program guide (EPG) or an electronic content guide (ECG). The ECG is used to present a user optional television programs. The information of a television program may comprise a caption of the television program, the IPTV channel ID, the start time and end time of the television program. The information of the television program may further comprise other information, such as the provider, date, media type, class, actor/director.

The request may be sent by a user over a network. This network may be of any type of communication network. For example, networks implemented according to standards, such as IEEE 802.3, 10/100 Ethernet of class 5, HPNA, HomePlug Powerline Alliance, IEEE 802.11x, IEEE 1394, USB 1.1/2.0.

Secondly, the viewing behavior of the user toward the television program is monitored according to the advertisement policy of the IPTV channel (step S120).

The advertisement policy of the IPTV channel may be providing the user with an advertisement segment of three minutes if the user has viewed the television programs of the IPTV channel over 30 minutes. According to the advertisement policy, the accumulative time of the user viewing the television programs of the IPTV channel is recorded.

While recording the accumulative time of the user viewing the television programs of the IPTV channel, if the user performs operations like channel switch, fast forward, fast backward, pause, or stop viewing the television program, the recording is paused and the current accumulative time of the user viewing the television programs of the IPTV channel is stored temporarily. The temporarily stored accumulative time can be cleared to zero after a certain period of time, such as one day.

When the user continues to normally view the television program (e.g., pause is cancelled or the IPTV channel is switched back), the last accumulative time of the user viewing the television programs of the IPTV channel is read and the recording of the accumulative time of the user viewing the television programs of the IPTV channel is resumed. The television program being normally viewed continuously may be same as or different from the television program normally viewed last time.

Thirdly, whether the viewing behavior matches the advertisement policy is determined (step S130).

The monitored viewing behavior of the user on the IPTV channel is compared with the predefined advertisement policy of the IPTV channel, whether to insert the advertisement segment is determined based on the advertisement policy.

If the user has viewed the television programs of the IPTV channel he/she selected over 30 minutes, the viewing behavior matches the viewing behavior of a user viewing the television program defined in the advertisement policy.

Fourthly, if the decision result is true, the advertisement segment is inserted into the television program (step S140).

If the advertisement segment needs to be inserted in accordance with the advertisement policy, the advertisement segment is inserted into the television program. The location information of the program into which the advertisement needs to be inserted is read, the program location is the location of the television program when the user has viewed the television programs of the IPTV channel over 30 minutes. According to the advertisement policy, an advertisement segment of three minutes is acquired and inserted into the television program at the location where the advertisement segment needs to be inserted.

Such an insertion may generate an integrated stream by inserting the advertisement segment into the television program. The detailed procedure comprises: compression encoding and transcoding the advertisement segment and the television program, and generating an integrated stream.

The advertisement segment and the television program can be encoded with various encoding standards supporting the IPTV encoding/decoding standard, such as the Motion Picture Experts Group (MPEG)-4 standard, the video-conferencing standard H.263 issued by ITU-T.

The encoding concept of MPEG-4 is an object-based encoding concept, i.e. dividing a scene into a number of audio and video objects temporally and spatially associated with each other when encoding, having encoded these objects respectively, multiplexing them to the receiving end, decoding different objects respectively, and thus combining them into the desired audio and video.

The encoding of MPEG-4 may employ the following techniques:

(1) Video object extraction technique: the primary task of realizing content based interaction is to divide a video/image into various objects or to separate the motion objects from the background, and then employ corresponding encoding methods for various objects to realize high efficient compression.

(2) VOP video encoding technique: different encoding policies are employed for different VOs in the process of encoding, details and smoothness are kept as much as possible for the compression encoding of the foreground VO; the encoding policy with high compression rate is employed for the background VO, or even the background VO is not transmitted and will be formed by concatenating other backgrounds at a decoding end.

(3) Video encoding scalability technique: with the significant increase of Internet services, there are more and more needs and applications for transmitting video over IP networks with great fluctuant rate and heterogeneous networks with different transmission features. MPEG-4 realizes scalable encoding through Video Object Layer (VOL) data structure. MPEG-4 provides two kinds of basic scalability tools, i.e. temporal scalability and spatial scalability, furthermore it supports the mixture of temporal scalability and spatial scalability. Each scalability encoding has at least two layers of VOL, the lower one is referred to as a basic layer, while the higher one is referred to as an enhanced layer. The basic layer provides the basic information of a video sequence, and the enhanced layer provides higher resolution and details of the video sequence.

(4) Motion estimation and motion compensation technique: MPEG-4 employs three types of frame formats, I-VOP, P-VOP and B-VOP, to characterize different motion compensation types. It employs the half pixel searching technique and the overlapped motion compensation technique of H.263, and in the meanwhile introduces the repetitive padding technique and the modified block (polygon) matching technique to support a VOP area of any shape.

The process of generating an integrated stream may further comprise the step of enciphering and DRM packaging, because the television program delivered to a user may as well be a enciphered video/audio stream media program. From the DRM license server, the DRM authorization/key sent by the identified user or user terminal unit is acquired, the television program is then enciphered and DRM packaged.

Fifthly, the integrated stream is sent to the user in the IPTV broadcast mode (step S150).

In the IPTV system, television programs are transmitted to a user end in stream mode over an IP backbone network and IP metropolitan area network by using the stream transmission technique. The stream transmission comprises the establishment of stream session, data packet encapsulation format, data packet transmission format, processing of pause/fast forward/fast backward requests of the user, correspondingly, the stream transmission technique comprises stream control protocol, file packaging format, stream transmission protocol, and etc.

In general, a television program is completed mainly through a Content Delivery Network (CDN), i.e. the audio/video data of the television program is copied to an edge server at the edge of the network through the CDN, and then is transmitted to the set-top box through the stream transmission technique, so as to realize the “playing while downloading” function. There are two kinds of stream transmission modes, i.e. Internet Streaming Media Alliance (ISMA) mode and MPEG-2 TS over IP mode.

1. ISMA Mode

The basic stream transmission procedure of ISMA is as follows: ISMA realizes the transmission of streaming data through the client/server structure, employs RTSP control protocol at an application layer, media data is carried on TCP or UDP after being encapsulated with RTP, and the transmission quality is monitored with RTP/RTCP protocol.

2. MPEG-2 TS Over IP Mode

Likewise, MPEG-2 TS over IP mode employs the client/server structure. Since the ISO/IEC 13818-1 standard does not define the control layer protocol, after this standard is applied to IPTV, the Real Time Streaming Protocol or the Hypertext Transfer Protocol can be employed at the control layer in MPEG-2 TS over IP mode, media data is generally carried on User Datagram Protocol (UDP) after being encapsulated with MPEGS TS. To avoid network jitter, the Real time Transport Protocol (RTP) can be employed above the UDP to encapsulate TS packages.

A television program may be transmitted with different bottom layer physical networks, such as IP over SDH/SONET (i.e. packet over SDH/SONET), IP over ATM or IP over DWDM optical (e.g. GB/10 GB optical Ethernet). The digital television propagator or the digital television operator can access the network according to corresponding bandwidth, such as Cable Modem network or DSL network, to transmit to a user a television program stream in IP over DOCSIS mode or IP over DSL mode through the DSLAM device.

After transmitting the integrated stream to a user, if the user continues to view the television program of the IPTV channel, after the advertisement of three minutes elapses, the length of time during which the user views the IPTV channel will be cleared to zero, and the accumulative time of the user viewing the television programs of the IPTV channel will be recorded for the next time, when the accumulative time again reaches 30 minutes, an advertisement of three minutes is inserted again according to the advertisement policy predefined by the IPTV channel.

If the server of the IPTV broadcaster detects that the user has a channel switching behavior during the playing time of three minutes advertisement, the transmission of the integrated stream is paused, and will be resumed after the user switches back to the IPTV channel.

According to the invention, whenever the accumulative time of the user viewing the television programs of the IPTV channel reaches 30 minutes, the advertisement policy predefined by the IPTV channel is performed automatically and an advertisement of three minutes is inserted. Therefore, during the user viewing the network television program, the user will have to view the advertisement segment according to the predefined advertisement policy even though the user performs operations such as channel switching, fast forward, fast backward, or re-log in the IPTV service.

Once the user uses the IPTV service, the monitoring behavior in step S140 is triggered and will be performed continuously, thus, for various advertisement policies, the monitoring behavior may obtain the user's corresponding behavior for a television program, an IPTV channel, or multiple IPTV channels performing the same advertisement policy.

The inserting in step S140 can be performed by seamlessly switching between the advertisement segment program stream and the television program stream.

FIG. 2 is the schematic flow chart of a method for inserting an advertisement segment into a television program of an IPTV channel according to another embodiment of the invention. The television program is being viewed by a user.

The advertisement policy of the IPTV channel comprises: providing the user with the advertisement segment based on the program location of a television program of the IPTV channel being viewed by the user. For example, the total length of the television program is 100 minutes, the advertisement policy of the IPTV channel is: inserting an advertisement segment A at the location of 25 minutes of the television program, inserting an advertisement segment B at the location of 50 minutes of the television program, and inserting an advertisement segment C at the location of 75 minutes of the television program. If the user relocates the television program, the location before relocating and the location after relocating pass by the above location where an advertisement segment should be inserted, the corresponding advertisement segment is inserted at the location where the television program is relocated. The advertisement policy can be described in an XML file.

After the request from the user that asks for viewing a television program of an IPTV channel is received (step S110), the television program is transmitted to the user.

Next, a request from the user that asks for relocating the location of the television program is received (step S121).

When the playing of the television program reaches 30 minutes, a request from the user that asks for relocating the location of the television program is received. For example, it requires to fast forward the television program to the 60 minutes location of the television program. The request for relocation may be that the user directly relocates to the 60 minutes location of the television program based on the location information of the television program, and may also be that the device at user end relocates to the 60 minutes location of the television program when reconnecting to the network of the digital television broadcaster or of the digital television operator of IPTV after disconnecting therefrom.

A first location of the segment before the user asking for relocation in the television program is recorded (step S122). A first location of the segment before the user asking for relocation in the television program is at the 30 minutes location of the television program.

A second location of the segment after relocation in the television program is recorded (step S123). A second location of the segment after relocation in the television program is at the 60 minutes location of in the television program.

According to the advertisement policy, whether to insert an advertisement segment into the television program between the first location and the second location is determined (step S131).

According to the advertisement policy, between the first location, i.e. the 30 minutes location of the television program, and the second location, i.e. the 60 minutes location of the television program, a location where an advertisement segment needs to be inserted is passed, this is the 50 minutes location of the television program. According to the advertisement policy, an advertisement segment B should be inserted into the 50 minutes location of the television program.

The advertisement segment is inserted before the second location of the television program (step S141). The advertisement segment B is inserted before the television program at the 60 minutes location.

The advertisement segment B and the content after the second location of the television program, i.e. the television program after the 60 minutes location of the television program, are integrated to generate an integrated stream. During the process of generating an integrated stream, the steps of enciphering and DRM packaging can also be included.

In the invention, the advertisement policy may further comprise providing the user with the advertisement segment based on the type of the television program the user is viewing. For example, an advertisement segment of 5 minutes is inserted before the start of a news program when a user is viewing the news program; an advertisement segment of 2 minutes is inserted every 30 minutes of a sports program when a user is viewing the sports program; an advertisement segment of 3 minutes is inserted every 20 minutes of a teleplay when a user is viewing the teleplay. According to the advertisement policy, the type of the television program the viewer is viewing is determined. Based on the type of the television program the user is viewing, the advertisement segments are inserted into the television program.

FIG. 3 is the schematic structural diagram of an apparatus 30 for inserting an advertisement segment into a television program of an IPTV channel according to an embodiment of the invention. The apparatus 30 may be a part of the server of the network digital television broadcaster or the digital television operator. The television program is being viewed by a user.

The apparatus 30 is used for inserting an advertisement segment into a television program of an IPTV channel, wherein the IPTV channel performs a predefined advertisement policy, the advertisement policy comprises providing an advertisement segment based on a viewing behavior of a user on the IPTV channel, the apparatus 30 comprises: a receiver 310, a monitor 320, a matcher 330 and an inserter 340.

The apparatus 30 may further comprise a transmitter 350 and a data storage unit 360.

The data storage unit 360 may comprise components such as a storage device, a storage network and a management software, wherein the storage device may be memory, disk array, optical disk array or data stream magnetic tape. The storage network is formed by connecting the storage device with the storage management server, it mainly includes architectures such as DAS (Direct Access Storage), NAS (Network Access Storage), SAN (Storage Area Network), etc. The storage management software may provide storage management functions like virtual storage, sharing, migration, backup, restoring.

The data storage unit 360 may store a user profile database 361, an advertisement policy database 362, a program content database 363, and an advertisement content database 364. One and more of the user profile database 361, the advertisement policy database 362, the program content database 363, and the advertisement content database 364 may be stored on the server of the digital television broadcaster or the digital television operator.

The user profile database 361 is used for storing a user's data, including the account information and the history of viewing the television programs of the user. The user profile database 361 further stores the user's personal preference. The user's personal preference comprises both the user's preference to television program contents and the user's preference to advertisement contents.

The advertisement policy database 362 is used for storing the advertisement policies of one or more IPTV channels. The advertisement policy of an IPTV channel may comprise: providing the user with the advertisement segment based on the length of time during which the user has viewed the television program; providing the user with the advertisement segment based on the program location of the television program the user is viewing; providing the user with the advertisement segment based on the type of the television program the user is viewing. Each IPTV channel can perform the same or different advertisement policies. The advertisement policy of an IPTV channel may further comprise transmitting to a user the advertisements conforming to the user's personal preference. Furthermore, multiple IPTV channels can perform a common advertisement policy.

The program content database 363 is used for storing various television program sources, including various types of television programs, such as teleplays, movies, concerts, news, sports, biographies, and etc. These television programs can be obtained through network measures, such as satellite, CATV network, terrestrial wireless and IP/ATM, or obtained directly through the manners of optical discs, memories.

The advertisement content database 364 is used for storing various advertisement segments.

The receiver 310 is used for receiving a request from a user thatasks for viewing a television program of an IPTV channel. The request comprises the user's information and the information of the television program.

The user's information may comprise the registration information, the account information, and the history of viewing the television programs of the IPTV, etc, of the user.

The information of the television program may originate from ECG (Electronics Content Guide), ECG is used for presenting the user optional television programs. The information of the television program may comprise the television program caption, IPTV channel ID, the start time and end time of the television program. The information of the television program may further comprise other information, such as the provider, date, media type, class, actor/director, and etc.

The request may be sent by a user over a network. This network may be any type of communication network. For example, networks implemented according to standards, such as IEEE 802.3, 10/100 Ethernet of class 5, HPNA, HomePlug Powerline Alliance, IEEE 802.11x, IEEE 1394 and USB 1.1/2.0, etc.

The monitor 320 is used for monitoring the viewing behavior of the user toward the television program according to the advertisement policy of the IPTV channel. The monitor 320 receives a predefined advertisement policy from the advertisement policy database 362. The advertisement policy may comprise: providing the user with the advertisement segment based on the length of time during which the user has viewed the IPTV channel, for example, the advertisement policy of the IPTV channel in which the television program the user asking for viewing is located is: providing the user with an advertisement segment of three minutes if the user has viewed the television program over 30 minutes. According to the advertisement policy, the monitor 320 records the time for the user to view the television program. The monitor 320 may also be used for recording the time the user to view the advertisement segment.

The monitor 320 may also be used for obtaining the program location information of the television program the user is viewing and sending the location information to the user profile database 361.

The matcher 330 is used for determining, for the viewing behavior, whether to insert the advertisement segment according to the advertisement policy. The matcher 330 compares the monitoring result of the monitor 320, i.e. the viewing behavior of the user towards the television program, with the advertisement policy predefined in the advertisement policy database 362, to determine, for the viewing behavior, whether to insert the advertisement segment according to the advertisement policy.

If the user has viewed the television program of the selected IPTV channel over 30 minutes, the matcher 330 may send a control signal to an inserter 340.

If the user pauses/stops viewing the television program when the time for the user to view the television program of the selected IPTV channel does not reach 30 minutes, the monitor 320 sends the accumulative time of the user viewing the IPTV channel to the user profile database 361 for temporary storage.

The inserter 340 is used for inserting the advertisement segment into the television program if the decision result is true. The inserter 340 receives a control signal sent from the matcher 330, then, reads the information of the location where the advertisement segment needs to be inserted from the user profile database 361, the location is the one where the television program is located when the length of time during which the user has viewed the television of the IPTV channel reaches 30 minutes. Next, the inserter 340 acquires an advertisement content of three minutes from the advertisement content database 364 and inserts said advertisement segment at the location where the advertisement segment needs to be inserted.

The monitor 320 records the time the user takes to view the advertisement segment when the user is viewing an advertisement segment. If the user wants to skip the advertisement segment by a fast forwarding or relocating method, the inserter 340 may acquire an advertisement content from the advertisement content database 364 and continue to insert the advertisement segment at the location where the advertisement segment needs to be inserted until the length of time during which the user has viewed the advertisement reaches three minutes.

The inserter 340 may comprise an integrator 342 and/or a switcher 344.

The integrator 342 integrates the advertisement segment and the television program to generate an integrated stream, the generator 350 compression encodes and transcodes the advertisement segment and the television program, and generates an integrated stream. The integrator 342 is also used for enciphering and DRM packaging the advertisement segment and the television program during the process of generating an integrated stream.

The switcher 344 is used for seamless switching between the advertisement segment stream and the television program stream based on the control signal from the matcher 330.

The transmitter 350 transmits the integrated stream to the user. The transmitter 350 is also used for transmitting the advertisement segment stream and the television program stream to the user.

The transmitter 350 transmits the television program in stream mode to the user end over an IP backbone network and IP metropolitan area network. The transmitter 350 may be part of the stream transmission server. The transmitter 350 is used for processing the establishment of the stream session, data packet encapsulation format, data packet transmission format, pause/fast forward/fast backward requesting process of the user, etc. Correspondingly, the stream transmission technique employed by the transmitter 350 comprises stream control protocol, file packaging format, stream transmission protocol, and etc.

In this embodiment, if the advertisement policy comprises providing the user with the advertisement segment based on the location of the television program being viewed by the user, the monitor 320 is used for tracking the location of the segment of the television program being viewed by the user in the television program.

In this embodiment, if the advertisement policy comprises providing the user with the advertisement segment based on the type of the television program being viewed by the user, the monitor 320 is used for determining the type of the television program being viewed by the user.

The present invention can also be implemented through a suitably programmed computer, the program equipped on the computer provides a computer program product, the computer program product is used for inserting an advertisement segment into a television program of an IPTV channel, comprising: code for receiving a request from a user that asks for viewing the television program; code for monitoring the viewing behavior of the user on the IPTV channel according to an advertisement policy of the IPTV channel, the advertisement policy comprising providing an advertisement segment based on the viewing behavior of the user on the IPTV channel; code for determining whether the monitored viewing behavior matches the advertisement policy; and code for inserting the advertisement segment into the television program if they match.

Such kind of computer program product may be stored in a storage carrier.

These program code parts can be provided to a processor to form a machine in order that the codes executed on the machine are used for implementing the above functions.

In the embodiments of the invention, an advertisement segment may comprise two or more advertisement sub-segments, such as a shoes advertisement, a car advertisement and a food advertisement.

It should be noted that the above embodiments are only descriptive rather than limiting the invention, those skilled in the art can design various alternative embodiments without departing from the scope of the appended claims. In the claims, the signs in brackets should not be explained as limiting the claim. The word “comprise” or “include” does not exclude the element or step not listed in the claim. The word “a” or “an” does not exclude the presence of a plurality of such elements. The invention can be implemented with a hardware comprising a number of specific elements, or a suitably programmed computer. In the apparatus claims which list a number of devices, some of these devices can be implemented with the one or the same hardware item.

1. A method for inserting an advertisement segment into a television program of an Internet Protocol Television channel, the method comprising the steps of:
(a) receiving a request from a user that asks for viewing the television program;
(b) monitoring the viewing behavior of the user on the IPTV channel according to an advertisement policy of the IPTV channel, the advertisement policy comprising providing an advertisement segment based on the user's viewing behavior on the IPTV channel;
(c) determining whether the monitored viewing behavior matches the advertisement policy;
(d) if the monitored viewing behavior matches the advertisement policy, inserting the advertisement segment into the television program.

2. The method as claimed in claim 1, wherein step (d) comprises the step of inserting the advertisement segment into the television program to generate an integrated stream.

3. The method as claimed in claim 1, wherein said advertisement policy comprises providing the user with the advertisement segment based on the length of time during which the user has viewed the television program, step (b) comprises: recording the time for the user to view the television program.

4. The method as claimed in claim 1, wherein said advertisement policy comprises providing the user with the advertisement segment based on a location of the television program viewed by the user, step (b) comprises tracking the location of a segment of the television program viewed by the user in the television program.

5. The method as claimed in claim 4, wherein step (b) comprises:
receiving a request from the user that asks for relocating the program position of the television program;
recording a first location in the television program of the segment before the user asks for relocation;
recording a second location in the television program of the segment after relocation;
step (c) comprises:
determining whether it needs to insert the advertisement segment into the television program between the first position and the second position according to the advertisement policy;
step (d) comprises:
if the decision result of step (c) is true, inserting the advertisement segment before the second position in the television program.

6. The method as claimed in claim 1, wherein said advertisement policy comprises providing the user with the advertisement segment based on the type of the television program viewed by the user, step (b) comprises determining the type of the television program being viewed by the user.

7. An apparatus for inserting an advertisement segment into a television program of an IPTV channel, the apparatus comprising:
a receiver for receiving a request from a user that asks for viewing the television program;
a monitor for monitoring the viewing behavior of the user on the IPTV channel according to an advertisement policy of the IPTV channel, the advertisement policy comprising providing the user with the an advertisement segment based on the user's viewing behavior on the IPTV channel;
a matcher for determining whether the monitored viewing behavior matches the advertisement policy;
an inserter for inserting the advertisement segment into the television program if the viewing behavior matches the advertisement policy.

8. A computer program product for inserting an advertisement segment into a television program of an IPTV channel, the computer program product comprising:
code for receiving a request from a user that asks for viewing the television program;
code for monitoring the viewing behavior of the user on the IPTV channel according to an advertisement policy of the IPTV channel, the advertisement policy comprising providing an advertisement segment based on the viewing behavior of the user on the IPTV channel;
code for determining whether the monitored viewing behavior matches the advertisement policy;
code for inserting the advertisement segment into the television program if the monitored viewing behavior matches the advertisement policy.

9. A storage carrier containing the computer program product as claimed in claim 8.
